(19) United States
(12) Patent Application Publication
(10) Pub. No.: US 2026/0056682 A1
(43) Pub. Date: Feb. 26, 2026

(54) READ LOOKAHEAD ACTIVATION IN A MEMORY SYSTEM

(71) Applicant: Micron Technology, Inc., Boise, ID (US)

(72) Inventor: Nitul Gohain, Bangalore (IN)

(21) Appl. No.: 19/304,442

(22) Filed: Aug. 19, 2025

Related U.S. Application Data
(60) Provisional application No. 63/687,248, filed on Aug. 26, 2024.

(51) Int. Cl. G06F 3/06

(52) U.S. Cl. CPC G06F 3/0659; G06F 3/0604; G06F 3/0656; G06F 3/0679

(57) ABSTRACT

Methods, systems, and devices for read lookahead activation in a memory system are described. A memory system may activate a read lookahead mode, which may enable the memory system to pre-load, to a cache buffer, logical to physical (L2P) mapping information for logical block addresses (LBAs) of a read command that are sequential to an LBA indicated by previous a read command. In some examples, activation of the read lookahead mode may be in response to identification of a sequential read workload. For example, the memory system may increment a counter to determine that a quantity of read commands received are for sequential LBAs, thereby determining that the command sequence is sequential in nature. The memory system may utilize the pre-loaded L2P mapping information to perform commands received from a host system in accordance with a sequential read pattern.

### CROSS REFERENCE

The present Application for Patent claims priority to U.S. Patent Application No. 63/687,248 by Gohain, entitled “READ LOOKAHEAD ACTIVATION IN A MEMORY SYSTEM,” filed Aug. 26, 2024, which is assigned to the assignee hereof, and which is expressly incorporated by reference in its entirety herein.

### TECHNICAL FIELD

The following relates to one or more systems for memory, including read lookahead activation in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports read lookahead activation in a memory system in accordance with examples as disclosed herein.

FIG. 2 shows an example of an architecture that supports read lookahead activation in a memory system in accordance with examples as disclosed herein.

FIG. 3 shows an example of a process that supports read lookahead activation in a memory system in accordance with examples as disclosed herein.

FIG. 4 shows a block diagram of a memory system that supports read lookahead activation in a memory system in accordance with examples as disclosed herein.

FIG. 5 shows a flowchart illustrating a method or methods that support read lookahead activation in a memory system in accordance with examples as disclosed herein.

### DETAILED DESCRIPTION

Some memory systems (e.g., in automotive applications) may include relatively limited memory capacity for storing data due to, for example, size constraints, among other examples. In such cases, the memory system may include a cache buffer, which may be used to temporarily store data during some types of operations. The data temporarily stored in the cache buffer may include logical to physical (L2P) mapping information (e.g., one or more L2P tables), which may map logical block addresses (LBAs) to physical addresses of one or more memory arrays. In some cases, the memory system may receive commands to read data at certain LBAs, and the memory system may add these commands to a queue. The memory system may include multiple dies which execute the received commands in parallel. However, in some cases (e.g., for some workloads) the memory system may receive a relatively low amount of work and the memory system may fail to keep the multiple dies occupied (e.g., busy). For example, the commands received may be for relatively small quantities of data (e.g., associated with a relatively small transfer size). Additionally, or alternatively, a quantity of commands received may be relatively small, resulting in a relatively small queue depth at the memory system. Thus, during some periods of operation of the memory system (e.g., due to low queue depth or small transfer size), some dies may be idle (e.g., not occupied), which may reduce system efficiency and performance.

In accordance with examples described herein, a memory system (e.g., an automotive memory system) may activate a read lookahead mode, which may enable the memory system to pre-load, to a cache buffer, L2P mapping information for LBAs that are sequential to an LBA indicated by a read command. In some examples, activation of the read lookahead mode may be in response to identification of a sequential read workload. For example, the memory system may increment a counter to determine whether a quantity of received read commands are for sequential LBAs. A value of the counter may indicate whether a command sequence is sequential in nature. By pre-loading, to the cache buffer, multiple L2P mapping tables for LBAs (e.g., according to a predicted pattern of sequential reads), the memory system may ensure that the multiple dies of the memory system are kept busy by improving parallel performance and execution of operations, which may increase the system efficiency and may reduce latency of access operations in cases of sequential read workflows. In some examples, the memory system may represent an example of or otherwise be included within an automotive system (e.g., an automotive solid-state drive (SSD)), and the techniques described herein for read lookahead activation may improve system efficiency and reduce latency within the automotive system, thereby improving overall performance.

In addition to applicability in memory systems as described herein, techniques for read lookahead activation in memory systems may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds and improving utilization of memory resources, which may decrease processing or latency times, improve response times, increase throughput, or otherwise improve user experience, among other benefits. Additionally, the memory system may be implemented within an automotive system (e.g., an automotive SSD), and may thereby support relatively high-performance and low-latency operations by the automotive system.

Features of the disclosure are illustrated and described in the context of systems, devices, and circuits. Features of the disclosure are further illustrated and described in the context of architectures, processes, block diagrams, and flowcharts.

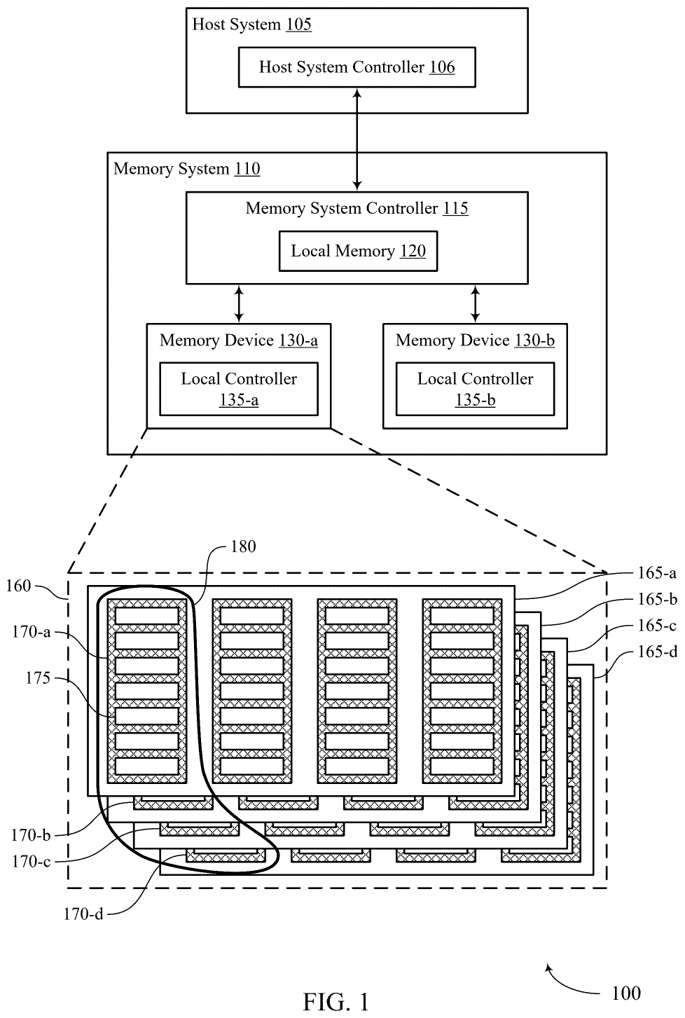

FIG. 1 shows an example of a system 100 that supports read lookahead activation in a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IOT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, an SSD, a hard disk drive (HDD), a dual in-line memory module (DIMM), a small outline DIMM (SO-DIMM), or a non-volatile DIMM (NVDIMM), among other devices. In some cases, the memory system 110 may be implemented as part of an automotive system (e.g., as an automotive SSD). For example, the host system 105 may be an example of a host system on an automotive platform.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

Some memory systems 110 (e.g., in automotive applications) may have relatively limited memory capacity for storing data. For example, a memory system 110 may include a cache buffer in local memory 120, which may be used to temporarily store data during some types of operations. The data temporarily stored in the cache buffer may include L2P mapping information (e.g., one or more L2P tables), which may map LBAs to physical addresses of one or more memory arrays (e.g., of memory devices 130). In some cases, the memory system 110 may receive commands (e.g., from a host system 105) to read data at certain LBAs, and the memory system 110 may add these commands to a queue. The memory system 110 may include multiple dies 160 which execute the received commands in parallel. However, in some cases (e.g., for some workloads) the memory system 110 may receive a relatively low amount of work and the memory system 110 may fail to keep the multiple dies 160 occupied (e.g., busy). For example, the commands received may be for small quantities of data (e.g., associated with a relatively small transfer size). Additionally, or alternatively, a quantity of commands received may be relatively small, resulting in a relatively small queue depth at the memory system. Thus, during some periods of time during operation of the memory system (e.g., due to low queue depth or small transfer size), some dies may be idle (e.g., not occupied), which may reduce system efficiency and performance.

In accordance with examples described herein, a memory system 110 may activate a read lookahead mode, which may enable the memory system 110 to pre-load, to a cache buffer in the local memory 120, L2P mapping information for LBAs that are sequential to an LBA indicated by a read command. In some examples, activation of the read lookahead mode may be in response to identification of a sequential read workload. For example, the memory system 110 may increment a counter to determine that a quantity of read commands received are for sequential LBAs, thereby determining that the command sequence is sequential in nature. By pre-loading multiple L2P mapping tables for LBAs (e.g., according to a predicted pattern of sequential reads), the memory system 110 may ensure that the multiple dies 160 of the memory system 110 are kept busy and may increase the system efficiency and may reduce latency of access operations in cases of sequential read workflows.

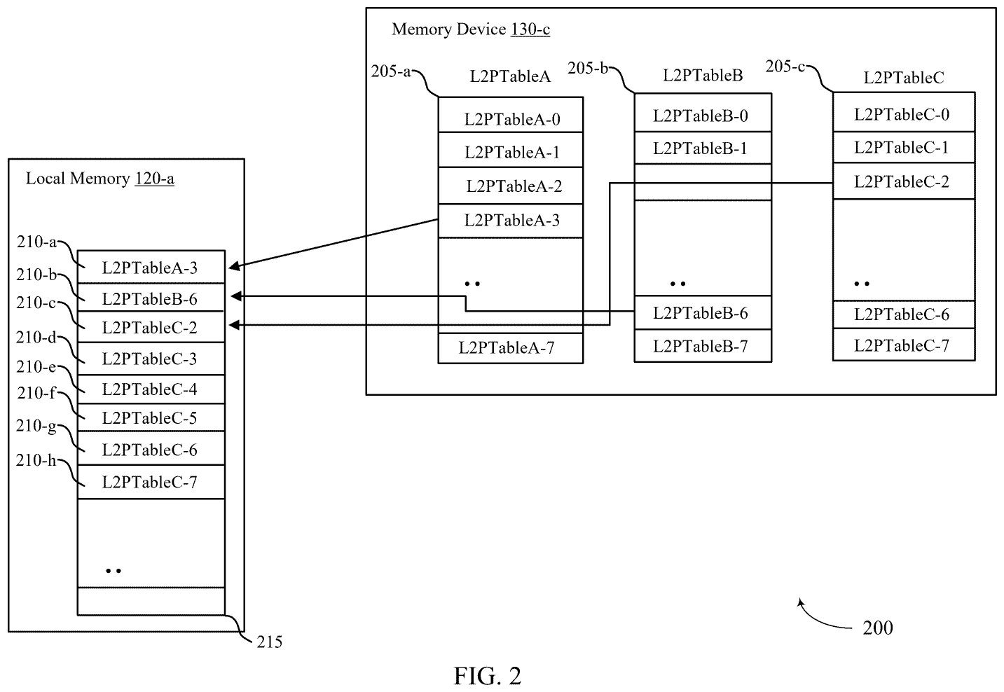

FIG. 2 shows an example of an architecture 200 that supports read lookahead activation in a memory system in accordance with examples as disclosed herein. The architecture 200 may implement or may be implemented by aspects of the system 100. For example, the architecture 200 may include a memory device 130-a and a local memory 120-a, which may be examples of corresponding devices or structures described herein. In some cases, the architecture 200 may be implemented in or as part of an automotive system, and architecture 200 may support improved throughput, reliability, and efficiency in automotive systems associated with relatively low queue depth, relatively small transfer sizes, or both, among other examples.

A memory system may store, at a memory device (e.g., in one or more NAND memory arrays), L2P mapping information. The L2P mapping information may otherwise be referred to herein as host to flash (H2F) mapping information, which may refer to information that translates a host address (e.g., an LBA, a host-readable address) to a physical address of memory stored in the memory device 130-c. In some examples, the memory system may store the L2P mapping information in multiple memory portions 205. Each memory portion 205 (e.g., an array, a table) may correspond to a plane 165, as described with reference to FIG. 1. For example, a memory portion 205-a may store the L2P mapping information (e.g., L2PTableA-0 through L2PTableA-7) for data stored in a plane 165-a, a memory portion 205-b may store the L2P mapping information (e.g., L2PTableB-0 through L2PTableB-7) for data stored in a plane 165-b, and a memory portion 205-b may store the L2P mapping information (e.g., L2PTableC-0 through L2PTableC-7) for data stored in a plane 165-c.

Each memory portion 205 may include one or more L2P tables 210 (e.g., H2F tables) each including mapping information for a subset of LBAs. For example, the memory portion 205-a may include L2PTableA-0 through L2PTableA-7, and each L2P table 210 within the memory portion 205-a may include a quantity (e.g., 512 or some other quantity) of entries of LBAs. Each successive L2P table 210 in a memory portion 205 may include entries for LBAs that are sequential to LBAs of the previous L2P table 210. For example, the L2PTableA-0 may include mapping information for LBAs 0 through 511, the L2PTableA-1 may include mapping information for LBAs 512 through 1023, and so on. In some examples, each L2P table 210 within the memory portion 205-a may have a size of 2 kilobytes (KB). In some other examples, each L2P table 210 within the memory portion 205-a may have a size different than 2 KB.

In some examples, the memory system may receive commands (e.g., from a host system 105) to read one or more LBAs. In response to the command, the memory system may load (e.g., read, fetch) L2P tables 210 from the memory portions 205 to local memory 120-a (e.g., to SRAM, to a cache buffer). The memory system may load the L2P tables 210 to a memory portion 215 (e.g., an array, a table) within the local memory 120-a that is reserved for storage of L2P tables 210. In some examples, the memory portion 215 may have a size of 64 KB and may have capacity to store 32 L2P tables 210. In some other examples, the memory portion 215 of the local memory 120-a may have different sizes or capacities for storing L2P tables 210, or the local memory 120-a may include multiple memory portions 215 for storing mapping information (e.g., L2P tables 210), among other examples. By loading the L2P tables 210 to the local memory 120-a, the memory system may support an increased speed of access of frequently or recently accessed memory, which may support increased system efficiency and reduced latency.

In some cases, a memory system may experience a relatively low workload, which may result from receiving a small quantity of commands (e.g., a low command queue depth) or receiving commands which request a relatively small quantity of data (e.g., a small transfer size). In such cases, dies of the memory system (e.g., dies 160, as described with reference to FIG. 1) may be left unoccupied. For example, the dies of the memory system may not have sufficient work to remain busy, which may reduce system efficiency of the memory system. In accordance with examples described herein, a memory system may activate a read lookahead mode, which may enable the memory system to pre-load (e.g., pre-fetch, pre-read), to the local memory 120-a (e.g., to the memory portion 215), L2P tables 210 for LBAs that are sequential to an LBA indicated by a read command.

In an illustrative example, the memory system may receive a first command to read a first set of LBAs which may cause the memory system to load the L2P table 210-a to the memory portion 215, a second command to read a second set of LBAs which may cause the memory system to load the L2P table 210-b to the memory portion 215, and a third command to read a third set of LBAs which may cause the memory system to load the L2P table 210-c to the memory portion 215. In some examples, in response to receiving the third command (e.g., and performing a read of the third set of LBAs), the memory system may perform read lookahead. For example, the memory system may pre-load the L2P table 210-e, the L2P table 210-f, the L2P table 210-g, and the L2P table 210-h to the local memory 120-a without receiving a command to read LBAs associated with any of the L2P table 210-e, the L2P table 210-f, the L2P table 210-g, and the L2P table 210-h. In some examples, the memory system may load the L2P table 210-e, the L2P table 210-f, the L2P table 210-g to the local memory 120-a with (e.g., simultaneously, in parallel with, immediately after) the L2P table 210-d. To perform the read lookahead, the memory system may pre-load the remaining L2P tables 210 (e.g., L2PTableC-3 through L2PTable3-7) from the memory portion 205-c that share a same plane with the L2P table 210-d and that are subsequent to the L2P table 210-d.

In some examples, performing the read lookahead may be based on a capacity of the memory portion 215. For example, the memory system may pre-load L2P tables 210 until the memory portion 215 is full. In some examples, the memory portion 215 may reach full capacity before the memory system pre-loads the remaining L2P tables 210 (e.g., L2PTableC-3 through L2PTable3-7) and the memory system may refrain from pre-loading additional L2P tables 210 in response to the memory portion 215 being full. Alternatively, the memory system may perform wrap-around based on the memory portion 215 being full. For example, the memory system may load L2P tables 210 to a beginning of (e.g., a starting address of) the memory portion 215 (e.g., overwriting the L2P table 210-a), or to a different portion of memory within the local memory 120-a, among other examples. In some other examples, the memory system may pre-load the remaining L2P tables 210 (e.g., L2PTableC-3 through L2PTable3-7) and the memory portion 215 may have additional space available. In such examples, the memory system may pre-load L2P tables 210 from outside of the memory portion 205-c (e.g., from a different memory portion 205, a different plane, a different die, etc.).

The memory system may perform read lookahead based on one or more criteria associated with incoming commands (e.g., from a host system 105). In some examples, the memory system may perform read lookahead based on determining that a sequence (e.g., a flow) of commands received from a host system (e.g., over a duration) is for reads of sequential LBAs (e.g., a sequential read flow). For example, the memory system may perform read lookahead based on receiving a threshold quantity of read commands that are for sequential LBAs. The memory system may maintain a command counter (e.g., in the local memory 120-a or elsewhere in memory) and may update the counter with each command received. For example, the memory system may increment the counter in response to receiving a command to read a first set of LBAs that is sequential to or overlaps with a second set of LBAs of a prior read command. Additionally, or alternatively, the memory system may perform read lookahead based on the sequence of commands received from the host system including a ratio of read commands to write commands that exceeds a threshold within some threshold duration (e.g., a read intensive command flow).

In accordance with these and other examples, the memory system may support read lookahead to pre-load mapping information for LBAs sequential to one or more LBAs indicated by a read command, which may be expected to be read in the future in accordance with a sequential read pattern. By pre-loading the mapping information for sequential LBAs, the memory system may support increased system efficiency and reduced latency. For example, the memory system may review the pre-loaded mapping information before performing subsequent operations to optimize resource utilization. By fully utilizing the processing and memory capabilities (e.g., multiple dies) of the memory system and reducing idle time of processing resources, the memory system may increase the utilization of processing resources and increase memory access speeds, thereby improving user experience within systems, such as within automotive systems, among other examples.

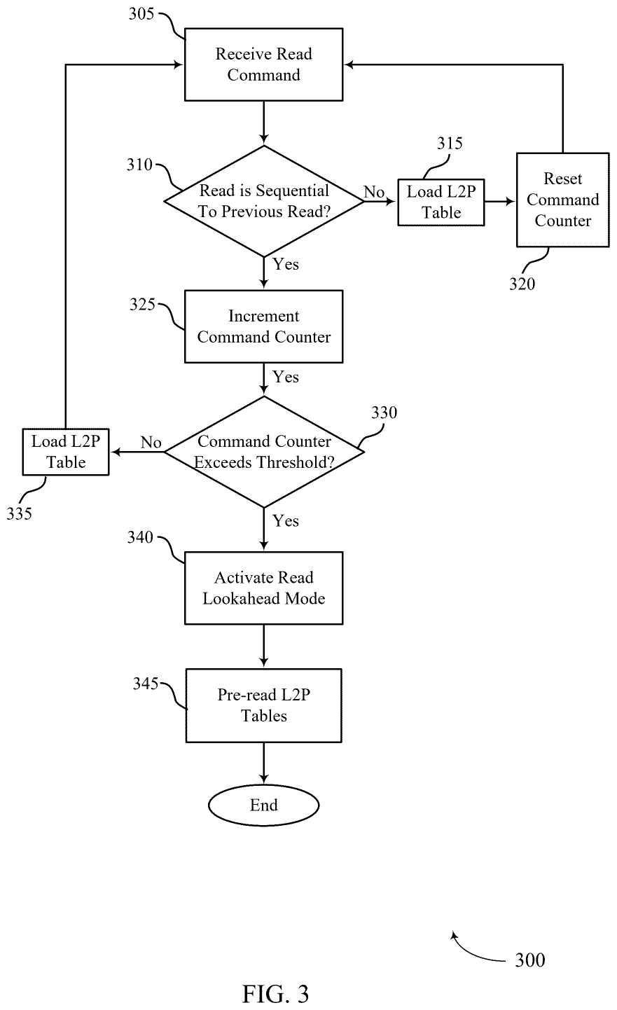

FIG. 3 shows an example of a process 300 that supports read lookahead activation in a memory system in accordance with examples as disclosed herein. Operations of the process 300 may be implemented by a memory system 110 (e.g., a memory system controller 115, one or more local controllers 135, or a combination thereof). The process 300 is depicted to start at 305 and end at 345, but may include additional operations (not shown), or operations may be omitted, modified, or performed in a different order in accordance with the described techniques.

At 305, the memory system may receive a second command to read second data associated with one or more second LBAs subsequent to receiving a first command to read first data associated with one or more second LBAs. In some examples, a transfer size (e.g., an amount of the first data, a first quantity of LBAs) requested by the first command may be different than a transfer size (e.g., an amount of the second data, a second quantity of LBAs) requested by the second command, or the transfer sizes for the two commands may be the same. In some examples, the memory system may be included in or otherwise associated with an automotive system, and the second read command may be associated with one or more automotive functions.

At 310, the memory system may determine whether the one or more second LBAs indicated by the second read command are sequential to (e.g., or overlapping with) the one or more first LBAs indicated by the first read command. To determine whether the first set of LBAs is sequential to or overlaps with the second set of LBAs, the memory system may determine whether at least one LBA (e.g., LBA 512) of the first set of LBAs (e.g., LBAs 512 through 1023) is sequential to at least one LBA (e.g., LBA 511) of the second set of LBAs (e.g., LBAs 0 through 511). If no single LBA of the second set of LBAs is sequential to any LBA of the first set of LBAs, the memory system may determine that the second set of LBAs is not sequential to the first set of LBAs. In some examples, the first command may indicate a starting LBA and an offset (e.g., a SectorCount). In such examples, determining that the second set of LBAs is sequential to the first set of LBAs may be based on the starting LBA and the offset. For example, the sets of LBAs may be sequential if a starting LBA of the second set of LBAs is less than or equal to a sum of the starting LBA of the first set of LBAs and the offset.

If, at 310, the memory system determines that the one or more second LBAs are not sequential to the one or more first LBAs, the process 300 may proceed to 315 where the memory system may load first mapping information (e.g., an L2P table 210-c, an H2F table) associated with the one or more second LBAs from one or more memory arrays (e.g., a memory device 130-a, memory portions 205) of the memory system to a cache buffer (e.g., a local memory 120-a, a memory portion 215). At 320, the memory system may reset the counter (e.g., to zero) for tracking the quantity of sequential read commands received from the host system in response to determining that the one or more second LBAs are not sequential to the one or more first LBAs.

If, at 310, the memory system determines that the one or more second LBAs are sequential to the one or more first LBAs, the process 300 may proceed to 325 where the memory system may update (e.g., increment) a counter. The counter may be stored in SRAM (e.g., a local memory 120-a) or some other type of memory and may track a quantity of sequential read commands received from a host system (e.g., a host system of an automotive platform).

At 330, the memory system may compare a value of the command counter to a threshold value. The threshold may be a configured threshold or may be set by a customer or in a product data sheet for the memory system. The memory system may compare the value of the command counter to the threshold in response to updating the command counter at 325.

If, at 330, the memory system determines that the value of the counter does not satisfy the threshold (e.g., is less than the threshold), the process 300 may proceed to 335 where the memory system may load first mapping information (e.g., an L2P table 210-c) associated with the one or more second LBAs from one or more memory arrays (e.g., a memory device 130-a, memory portions 205) of the memory system to a cache buffer (e.g., a local memory 120-a, a memory portion 215).

If, at 330, the memory system determines that the value of the counter satisfies the threshold (e.g., is greater than or equal to the threshold), the process 300 may proceed to 340 where the memory system may activate a read lookahead mode. That is, if a threshold quantity of sequential reads are detected, the memory system may activate the read lookahead mode. The read lookahead mode may be associated with (e.g., may include) preloading mapping information to a cache buffer (e.g., a local memory 120-a) in response to receiving a threshold quantity of read commands that are associated with (e.g., indicate reads for) sequential LBAs. The memory system may activate the read lookahead mode in response to determining (e.g., at 330) that the value of the counter satisfies the threshold. Additionally, or alternatively, the memory system may activate the read lookahead mode in response to determining that a sequence of commands received from the host system is read intensive. For example, the memory system may determine that a ratio between a first quantity of read commands received within a first duration and a second quantity of write command received within the first duration satisfies a threshold (e.g., a threshold percentage, 80%, 90%, 95%, etc.).

At 345, after activating the read lookahead mode, the memory system may load, from one or more memory arrays (e.g., a memory device 130-a, memory portions 205) of the memory system to a cache buffer (e.g., a local memory 120-a, a memory portion 215), first mapping information (e.g., an L2P table 210-c) associated with the one or more second LBAs and second mapping information (e.g., an L2P table 210-d, an L2P table 210-c, an L2P table 210-f, an L2P table 210-g, an L2P table 210-h) associated with one or more third LBAs. The one or more third LBAs may be sequential to the one or more second LBAs. Additionally, or alternatively, the one or more third LBAs and the one or more second LBAs may be associated with a same plane. After 345, the process 300 may conclude. Alternatively, after 345, the process 300 may return to 305 (e.g., periodically) to evaluate incoming read commands from the host for performing additional read lookahead operations.

In some examples, after 345, the memory system may utilize the pre-loaded mapping information for performing a read of the one or more third LBAs. For example, the memory system may receive a command to read third data associated with the one or more third LBAs, and the memory system may read the third data associated with the one or more third LBAs based on the second mapping information that is loaded to the cache buffer (e.g., at 345). The second mapping information may provide for the memory system to accurately assign resources for execution of the various read operations, among other examples, which may improve efficiency and reliability of the operations within automotive systems, for example.

In some examples, after activating the read lookahead mode (e.g., at 340), the memory system may deactivate the read lookahead mode based on one or more criteria or trigger events. When the read lookahead mode is deactivated, the memory system may not pre-load mapping information, but may instead load the mapping information in response to each individual command. In some examples, the memory system may compare, similar to 310, LBAs in each received read command to LBAs in a prior read command to determine whether the commands are sequential. If the memory system determines (e.g., while the read lookahead mode is activated) that a set of LBAs indicated by a read command is not sequential to the prior read command, the memory system may deactivate the read lookahead mode. In some examples, the memory system may receive one or more write commands and may determine that a ratio between a first quantity of read commands received within a first duration and a second quantity of write commands received within the first duration satisfies a threshold. For example, the memory system may maintain one or more other counters, timers, or both for determining a read to write ratio. Accordingly, the memory system may deactivate the read lookahead mode based on determining that the ratio between incoming read commands and incoming write commands satisfies the threshold. For example, the memory system may deactivate the read lookahead mode based on a determination that the received commands over the first duration satisfy a write-intensive condition.

In some examples, the memory system may deactivate the read lookahead mode based on determining that a workload of the memory system is associated with a relatively high queue depth (e.g., high quantity of commands) or a relatively large transfer size (e.g., large amount of data per command). The memory system may be deployed with or otherwise receive an indication of respective threshold queue depths and threshold transfer sizes for deactivating read lookahead, in some examples. In some examples, the memory system may deactivate the read lookahead mode based on an amount of space available in buffers (e.g., a buffer capacity) at the memory system satisfying (e.g., being less than) a threshold. For example, the memory system may perform one or more processes associated with high buffer usage, such as garbage collection or wear-leveling, and the memory system may deactivate the read lookahead mode (e.g., and release SRAM reserved for read lookahead) based on the memory system performing the one or more processes.

In some examples, the memory system may deactivate the read lookahead mode based on a cache hit rate for the pre-loaded mapping information falling below a threshold. For example, the memory system may receive one or more third commands to read third data associated with the one or more third LBAs and may determine a cache hit rate associated with the second mapping information loaded to the cache buffer (e.g., at 345) based on executing the one or more third commands. The memory system may deactivate the read lookahead mode based on the determined cache hit rate satisfying a threshold. Additionally, or alternatively, the memory system may deactivate the read lookahead mode in response to the memory system transitioning from a first power mode to a second power mode (e.g., a low power mode, a device suspension) associated with lower power consumption than the first power mode.

Additionally, or alternatively, the memory system may deactivate the read lookahead mode based on one or more other processes or operations being performed at the memory system, one or more conditions being experienced by the memory system, or a combination thereof. For example, the memory system may deactivate the read lookahead mode based on a reset of the memory system, an asynchronous power loss condition, a clean power down, a format of non-volatile memory (NVM) (e.g., formatNVM), a sanitize operation, a low level format of the memory system, a firmware download, one or more NVM express (NVMe) commands (e.g., write-zeroes, write-uncorrectable), or a combination thereof. In some examples, the memory system may transition into or out of the read lookahead mode of the memory system (e.g., from deactivated to activated or from activated to deactivated) as part of a background task, which may reduce performance degradation.

In some examples, the memory system may invalidate data (e.g., mapping information) stored in a read lookahead cache buffer (e.g., the memory portion 215). In some examples, the memory system may invalidate the data stored in the read lookahead cache buffer without deactivating the read lookahead mode. The memory system may invalidate the data stored in the read lookahead cache buffer in response to a write command that writes data to an LBA corresponding to the second mapping information loaded to the read lookahead cache buffer (e.g., at 345). For example, the memory system may receive a command to write data to at least one LBA of the one or more third LBAs associated with the second mapping information. The memory system may write the data to the at least one LBA of the one or more third LBAs and may invalidate the second mapping information based on writing the data. Additionally, or alternatively, the memory system may invalidate the mapping information loaded to the cache buffer based on receiving a read command that indicates an LBA different than LBAs associated with the pre-loaded mapping information (e.g., a cache miss).

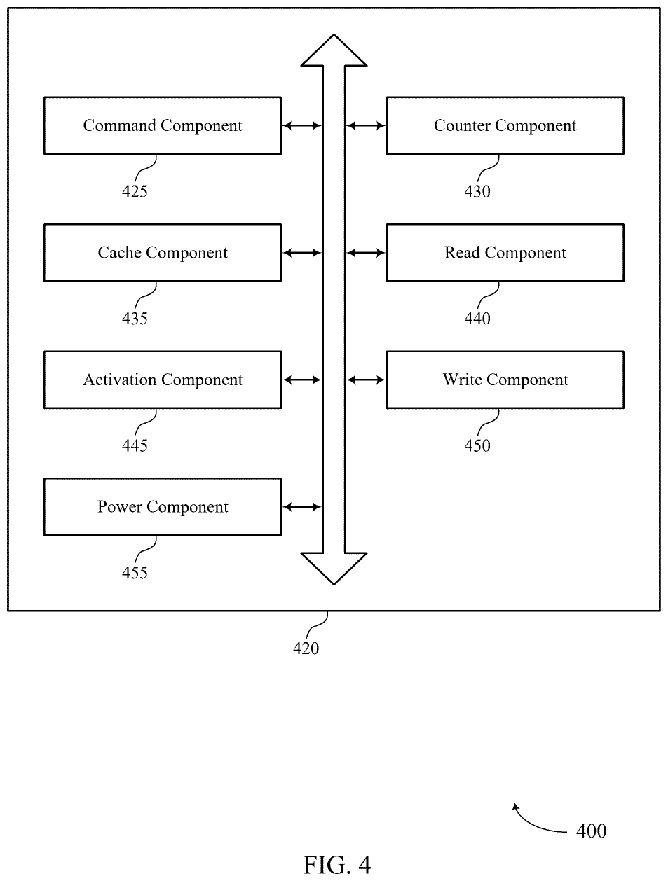

FIG. 4 shows a block diagram 400 of a memory system 420 that supports read lookahead activation in a memory system in accordance with examples as disclosed herein. The memory system 420 may be an example of aspects of a memory system as described with reference to FIGS. 1 through 3. The memory system 420, or various components thereof, may be an example of means for performing various aspects of read lookahead activation in a memory system as described herein. For example, the memory system 420 may include a command component 425, a counter component 430, a cache component 435, a read component 440, an activation component 445, a write component 450, a power component 455, or any combination thereof. Each of these components, or components of subcomponents thereof (e.g., one or more processors, one or more memories), may communicate, directly or indirectly, with one another (e.g., via one or more buses). In some examples, the memory system 420 may be implemented as part of an automotive system (e.g., an automotive SSD).

The command component 425 may be configured as or otherwise support a means for receiving a first command to read first data associated with one or more first LBAs and a second command to read second data associated with one or more second LBAs. The counter component 430 may be configured as or otherwise support a means for updating a counter based at least in part on at least one second LBA of the one or more second LBAs being sequential to at least one first LBA of the one or more first LBAs. In some examples, the counter component 430 may be configured as or otherwise support a means for determining whether a value of the counter satisfies a threshold based at least in part on updating the counter. The cache component 435 may be configured as or otherwise support a means for loading, from one or more memory arrays of the memory system to a cache buffer and based at least in part on determining that the value of the counter satisfies the threshold, first mapping information associated with the one or more second LBAs and second mapping information associated with one or more third LBAs that are sequential to the one or more second LBAs.

In some examples, the one or more third LBAs and the one or more second LBAs are associated with a same plane of the one or more memory arrays.

In some examples, the command component 425 may be configured as or otherwise support a means for determining whether a ratio between a first quantity of read commands received within a first duration and a second quantity of write commands received within the first duration satisfies a second threshold, where loading the second mapping information to the cache buffer is based at least in part on determining that the ratio is greater than the second threshold.

In some examples, the first command indicates a starting LBA and an offset associated with the one or more first LBAs, and the command component 425 may be configured as or otherwise support a means for determining that the at least one second LBA of the one or more second LBAs is sequential to the at least one first LBA of the one or more first LBAs based at least in part on the starting LBA and the offset.

In some examples, the command component 425 may be configured as or otherwise support a means for receiving a third command to read third data associated with one or more fourth LBAs. In some examples, the counter component 430 may be configured as or otherwise support a means for resetting the counter based at least in part on any LBA of the one or more fourth LBAs not being sequential to any LBA of the one or more second LBAs.

In some examples, the command component 425 may be configured as or otherwise support a means for receiving a third command to read third data associated with the one or more third LBAs. In some examples, the read component 440 may be configured as or otherwise support a means for reading the third data associated with the one or more third LBAs based at least in part on the second mapping information that is associated with the one or more third LBAs and is loaded to the cache buffer.

In some examples, the activation component 445 may be configured as or otherwise support a means for activating a read lookahead mode of the memory system based at least in part on determining that the value of the counter satisfies the threshold, the read lookahead mode associated with preloading mapping information to the cache buffer in response to receiving a threshold quantity of read commands associated with sequential LBAs, where loading the first mapping information and the second mapping information to the cache buffer is based at least in part on activating the read lookahead mode.

In some examples, the command component 425 may be configured as or otherwise support a means for receiving, after loading the first mapping information and the second mapping information to the cache buffer, one or more write commands. In some examples, the command component 425 may be configured as or otherwise support a means for determining whether a ratio between a first quantity of read commands received within a first duration and a second quantity of write commands received within the first duration satisfies a second threshold based at least in part on receiving the one or more write commands. In some examples, the activation component 445 may be configured as or otherwise support a means for deactivating the read lookahead mode of the memory system based at least in part on determining that the ratio is less than the second threshold.

In some examples, the command component 425 may be configured as or otherwise support a means for receiving one or more third commands to read third data associated with the one or more third LBAs. In some examples, the cache component 435 may be configured as or otherwise support a means for determining a cache hit rate associated with the second mapping information loaded to the cache buffer based at least in part on receiving the one or more third commands to read the third data. In some examples, the activation component 445 may be configured as or otherwise support a means for deactivating the read lookahead mode of the memory system based at least in part on the cache hit rate associated with the second mapping information satisfying a second threshold.

In some examples, the power component 455 may be configured as or otherwise support a means for transitioning the memory system from a first power mode to a second power mode associated with lower power consumption than the first power mode. In some examples, the activation component 445 may be configured as or otherwise support a means for deactivating the read lookahead mode of the memory system based at least in part on transitioning the memory system from the first power mode to the second power mode.

In some examples, the command component 425 may be configured as or otherwise support a means for receiving a third command to write third data to at least one LBA of the one or more third LBAs. In some examples, the write component 450 may be configured as or otherwise support a means for writing the third data to the at least one LBA of the one or more third LBAs. In some examples, the cache component 435 may be configured as or otherwise support a means for invalidating the second mapping information associated with the one or more third LBAs based at least in part on writing the third data.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

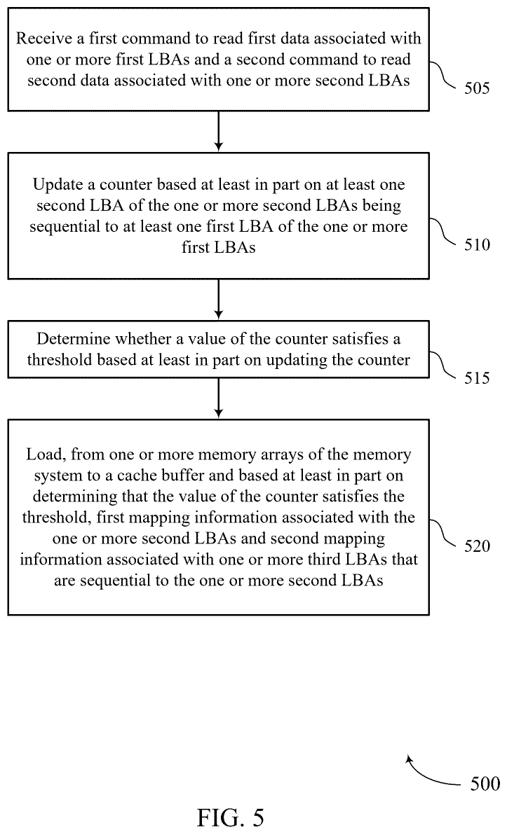

FIG. 5 shows a flowchart illustrating a method 500 that supports read lookahead activation in a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a first command to read first data associated with one or more first LBAs and a second command to read second data associated with one or more second LBAs. In some examples, aspects of the operations of 505 may be performed by a command component 425 as described with reference to FIG. 4.

At 510, the method may include updating a counter based at least in part on at least one second LBA of the one or more second LBAs being sequential to at least one first LBA of the one or more first LBAs. In some examples, aspects of the operations of 510 may be performed by a counter component 430 as described with reference to FIG. 4.

At 515, the method may include determining whether a value of the counter satisfies a threshold based at least in part on updating the counter. In some examples, aspects of the operations of 515 may be performed by a counter component 430 as described with reference to FIG. 4.

At 520, the method may include loading, from one or more memory arrays of the memory system to a cache buffer and based at least in part on determining that the value of the counter satisfies the threshold, first mapping information associated with the one or more second LBAs and second mapping information associated with one or more third LBAs that are sequential to the one or more second LBAs. In some examples, aspects of the operations of 520 may be performed by a cache component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a first command to read first data associated with one or more first LBAs and a second command to read second data associated with one or more second LBAs; updating a counter based at least in part on at least one second LBA of the one or more second LBAs being sequential to at least one first LBA of the one or more first LBAs; determining whether a value of the counter satisfies a threshold based at least in part on updating the counter; and loading, from one or more memory arrays of the memory system to a cache buffer and based at least in part on determining that the value of the counter satisfies the threshold, first mapping information associated with the one or more second LBAs and second mapping information associated with one or more third LBAs that are sequential to the one or more second LBAs.

Aspect 2: The method, apparatus, or non-transitory computer-readable medium of aspect 1, where the one or more third LBAs and the one or more second LBAs are associated with a same plane of the one or more memory arrays.

Aspect 3: The method, apparatus, or non-transitory computer-readable medium of any of aspects 1 through 2, further including operations, features, circuitry, logic, means, or instructions, or any combination thereof for determining whether a ratio between a first quantity of read commands received within a first duration and a second quantity of write commands received within the first duration satisfies a second threshold, where loading the second mapping information to the cache buffer is based at least in part on determining that the ratio is greater than the second threshold.

Aspect 4: The method, apparatus, or non-transitory computer-readable medium of any of aspects 1 through 3, where the first command indicates a starting LBA and an offset associated with the one or more first LBAs and the method, apparatuses, and non-transitory computer-readable medium further includes operations, features, circuitry, logic, means, or instructions, or any combination thereof for determining that the at least one second LBA of the one or more second LBAs is sequential to the at least one first LBA of the one or more first LBAs based at least in part on the starting LBA and the offset.

Aspect 5: The method, apparatus, or non-transitory computer-readable medium of any of aspects 1 through 4, further including operations, features, circuitry, logic, means, or instructions, or any combination thereof for receiving a third command to read third data associated with one or more fourth LBAs and resetting the counter based at least in part on any LBA of the one or more fourth LBAs not being sequential to any LBA of the one or more second LBAs.

Aspect 6: The method, apparatus, or non-transitory computer-readable medium of any of aspects 1 through 5, further including operations, features, circuitry, logic, means, or instructions, or any combination thereof for receiving a third command to read third data associated with the one or more third LBAs and reading the third data associated with the one or more third LBAs based at least in part on the second mapping information that is associated with the one or more third LBAs and is loaded to the cache buffer.

Aspect 7: The method, apparatus, or non-transitory computer-readable medium of any of aspects 1 through 6, further including operations, features, circuitry, logic, means, or instructions, or any combination thereof for activating a read lookahead mode of the memory system based at least in part on determining that the value of the counter satisfies the threshold, the read lookahead mode associated with preloading mapping information to the cache buffer in response to receiving a threshold quantity of read commands associated with sequential LBAs, where loading the first mapping information and the second mapping information to the cache buffer is based at least in part on activating the read lookahead mode.

Aspect 8: The method, apparatus, or non-transitory computer-readable medium of aspect 7, further including operations, features, circuitry, logic, means, or instructions, or any combination thereof for receiving, after loading the first mapping information and the second mapping information to the cache buffer, one or more write commands; determining whether a ratio between a first quantity of read commands received within a first duration and a second quantity of write commands received within the first duration satisfies a second threshold based at least in part on receiving the one or more write commands; and deactivating the read lookahead mode of the memory system based at least in part on determining that the ratio is less than the second threshold.

Aspect 9: The method, apparatus, or non-transitory computer-readable medium of any of aspects 7 through 8, further including operations, features, circuitry, logic, means, or instructions, or any combination thereof for receiving one or more third commands to read third data associated with the one or more third LBAs; determining a cache hit rate associated with the second mapping information loaded to the cache buffer based at least in part on receiving the one or more third commands to read the third data; and deactivating the read lookahead mode of the memory system based at least in part on the cache hit rate associated with the second mapping information satisfying a second threshold.

Aspect 10: The method, apparatus, or non-transitory computer-readable medium of any of aspects 7 through 9, further including operations, features, circuitry, logic, means, or instructions, or any combination thereof for transitioning the memory system from a first power mode to a second power mode associated with lower power consumption than the first power mode and deactivating the read lookahead mode of the memory system based at least in part on transitioning the memory system from the first power mode to the second power mode.

Aspect 11: The method, apparatus, or non-transitory computer-readable medium of any of aspects 1 through 10, further including operations, features, circuitry, logic, means, or instructions, or any combination thereof for receiving a third command to write third data to at least one LBA of the one or more third LBAs; writing the third data to the at least one LBA of the one or more third LBAs; and invalidating the second mapping information associated with the one or more third LBAs based at least in part on writing the third data.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a first command to read first data associated with one or more first logical block addresses and a second command to read second data associated with one or more second logical block addresses;
update a counter based at least in part on at least one second logical block address of the one or more second logical block addresses being sequential to at least one first logical block address of the one or more first logical block addresses;
determine whether a value of the counter satisfies a threshold based at least in part on updating the counter; and
load, from one or more memory arrays of the memory system to a cache buffer and based at least in part on determining that the value of the counter satisfies the threshold, first mapping information associated with the one or more second logical block addresses and second mapping information associated with one or more third logical block addresses that are sequential to the one or more second logical block addresses.

2. The memory system of claim 1, wherein the one or more third logical block addresses and the one or more second logical block addresses are associated with a same plane of the one or more memory arrays.

3. The memory system of claim 1, wherein the processing circuitry is further configured to cause the memory system to:
determine whether a ratio between a first quantity of read commands received within a first duration and a second quantity of write commands received within the first duration satisfies a second threshold, wherein loading the second mapping information to the cache buffer is based at least in part on determining that the ratio is greater than the second threshold.

4. The memory system of claim 1, wherein the first command indicates a starting logical block address and an offset associated with the one or more first logical block addresses, and the processing circuitry is further configured to cause the memory system to:
determine that the at least one second logical block address of the one or more second logical block addresses is sequential to the at least one first logical block address of the one or more first logical block addresses based at least in part on the starting logical block address and the offset.

5. The memory system of claim 1, wherein the processing circuitry is further configured to cause the memory system to:
receive a third command to read third data associated with one or more fourth logical block addresses; and
reset the counter based at least in part on any logical block address of the one or more fourth logical block addresses not being sequential to any logical block address of the one or more second logical block addresses.

6. The memory system of claim 1, wherein the processing circuitry is further configured to cause the memory system to:
receive a third command to read third data associated with the one or more third logical block addresses; and
read the third data associated with the one or more third logical block addresses based at least in part on the second mapping information that is associated with the one or more third logical block addresses and is loaded to the cache buffer.

7. The memory system of claim 1, wherein the processing circuitry is further configured to cause the memory system to:
activate a read lookahead mode of the memory system based at least in part on determining that the value of the counter satisfies the threshold, the read lookahead mode associated with preloading mapping information to the cache buffer in response to receiving a threshold quantity of read commands associated with sequential logical block addresses, wherein loading the first mapping information and the second mapping information to the cache buffer is based at least in part on activating the read lookahead mode.

8. The memory system of claim 7, wherein the processing circuitry is further configured to cause the memory system to:
receive, after loading the first mapping information and the second mapping information to the cache buffer, one or more write commands;
determine whether a ratio between a first quantity of read commands received within a first duration and a second quantity of write commands received within the first duration satisfies a second threshold based at least in part on receiving the one or more write commands; and
deactivate the read lookahead mode of the memory system based at least in part on determining that the ratio is less than the second threshold.

9. The memory system of claim 7, wherein the processing circuitry is further configured to cause the memory system to:
receive one or more third commands to read third data associated with the one or more third logical block addresses;
determine a cache hit rate associated with the second mapping information loaded to the cache buffer based at least in part on receiving the one or more third commands to read the third data; and
deactivate the read lookahead mode of the memory system based at least in part on the cache hit rate associated with the second mapping information satisfying a second threshold.

10. The memory system of claim 7, wherein the processing circuitry is further configured to cause the memory system to:
transition the memory system from a first power mode to a second power mode associated with lower power consumption than the first power mode; and
deactivate the read lookahead mode of the memory system based at least in part on transitioning the memory system from the first power mode to the second power mode.

11. The memory system of claim 1, wherein the processing circuitry is further configured to cause the memory system to:
receive a third command to write third data to at least one logical block address of the one or more third logical block addresses;
write the third data to the at least one logical block address of the one or more third logical block addresses; and
invalidate the second mapping information associated with the one or more third logical block addresses based at least in part on writing the third data.

12. A method by a memory system, comprising:
receiving a first command to read first data associated with one or more first logical block addresses and a second command to read second data associated with one or more second logical block addresses;
updating a counter based at least in part on at least one second logical block address of the one or more second logical block addresses being sequential to at least one first logical block address of the one or more first logical block addresses;
determining whether a value of the counter satisfies a threshold based at least in part on updating the counter; and
loading, from one or more memory arrays of the memory system to a cache buffer and based at least in part on determining that the value of the counter satisfies the threshold, first mapping information associated with the one or more second logical block addresses and second mapping information associated with one or more third logical block addresses that are sequential to the one or more second logical block addresses.

13. The method of claim 12, wherein the one or more third logical block addresses and the one or more second logical block addresses are associated with a same plane of the one or more memory arrays.

14. The method of claim 12, further comprising:
determining whether a ratio between a first quantity of read commands received within a first duration and a second quantity of write commands received within the first duration satisfies a second threshold, wherein loading the second mapping information to the cache buffer is based at least in part on determining that the ratio is greater than the second threshold.

15. The method of claim 12, wherein the first command indicates a starting logical block address and an offset associated with the one or more first logical block addresses, the method further comprising:
determining that the at least one second logical block address of the one or more second logical block addresses is sequential to the at least one first logical block address of the one or more first logical block addresses based at least in part on the starting logical block address and the offset.

16. The method of claim 12, further comprising:
receiving a third command to read third data associated with one or more fourth logical block addresses; and
resetting the counter based at least in part on any logical block address of the one or more fourth logical block addresses not being sequential to any logical block address of the one or more second logical block addresses.

17. The method of claim 12, further comprising:
receiving a third command to read third data associated with the one or more third logical block addresses; and
reading the third data associated with the one or more third logical block addresses based at least in part on the second mapping information that is associated with the one or more third logical block addresses and is loaded to the cache buffer.

18. The method of claim 12, further comprising:
activating a read lookahead mode of the memory system based at least in part on determining that the value of the counter satisfies the threshold, the read lookahead mode associated with preloading mapping information to the cache buffer in response to receiving a threshold quantity of read commands associated with sequential logical block addresses, wherein loading the first mapping information and the second mapping information to the cache buffer is based at least in part on activating the read lookahead mode.

19. The method of claim 18, further comprising:
receiving, after loading the first mapping information and the second mapping information to the cache buffer, one or more write commands;
determining whether a ratio between a first quantity of read commands received within a first duration and a second quantity of write commands received within the first duration satisfies a second threshold based at least in part on receiving the one or more write commands; and
deactivating the read lookahead mode of the memory system based at least in part on determining that the ratio is less than the second threshold.

20. The method of claim 18, further comprising:
receiving one or more third commands to read third data associated with the one or more third logical block addresses;
determining a cache hit rate associated with the second mapping information loaded to the cache buffer based at least in part on receiving the one or more third commands to read the third data; and
deactivating the read lookahead mode of the memory system based at least in part on the cache hit rate associated with the second mapping information satisfying a second threshold.

21. The method of claim 18, further comprising:
transitioning the memory system from a first power mode to a second power mode associated with lower power consumption than the first power mode; and
deactivating the read lookahead mode of the memory system based at least in part on transitioning the memory system from the first power mode to the second power mode.

22. A non-transitory computer-readable medium storing code, the code comprising instructions executable by one or more processors to:
receive a first command to read first data associated with one or more first logical block addresses and a second command to read second data associated with one or more second logical block addresses;
update a counter based at least in part on at least one second logical block address of the one or more second logical block addresses being sequential to at least one first logical block address of the one or more first logical block addresses;
determine whether a value of the counter satisfies a threshold based at least in part on updating the counter; and
load, from one or more memory arrays of a memory system to a cache buffer and based at least in part on determining that the value of the counter satisfies the threshold, first mapping information associated with the one or more second logical block addresses and second mapping information associated with one or more third logical block addresses that are sequential to the one or more second logical block addresses.
